(19) United States
(12) Patent Application Publication
(10) Pub. No.: US 2017/0228666 A1
(43) Pub. Date: Aug. 10, 2017

(54) Graphical Interfaces, Systems and Methods of Automation in the Creation of Open and Closed Networks and in the Dispatching of Rides through the Networks

(71) Applicant: Gary Bauer, San Francisco, CA (US)

(72) Inventor: Gary Bauer, San Francisco, CA (US)

(21) Appl. No.: 15/242,477

(22) Filed: Aug. 19, 2016

Related U.S. Application Data
(60) Provisional application No. 62/207,357, filed on Aug. 19, 2015.

(51) Int. Cl. G06Q 10/02

(52) U.S. Cl. CPC G06Q 10/02; G06Q 2240/00; G06F 3/0482

(57) ABSTRACT

A Destination Management Company (DMC) may be a hotel, corporation or other entity interested in arranging transportation. A DMC may retain or frequently use a Preferred Transpiration Provider (PTP) by use of a private or closed network. In times of normal ride demand, a PTP may be the exclusive ride vendor. A PTP may anticipate instances wherein ride demand may exceed a PTP's capacity and thus enter into relationships with affiliate providers by the creation of a Preferred Transport Provider Affiliate Network (PTPAN) wherein rides are orchestrated by use of the closed network. When a PTPAN's capacity is exceeded, the disclosed systems may create a new Dispatch Network based upon the PTPAN. In the event that demand outstrips the capacity of the closed network, a ride request may be transferred to an open network wherein other affiliates may service the ride request.

### RELATED PATENT APPLICATION AND INCORPORATION BY REFERENCE

This is a utility application based upon U.S. patent application Ser. No. 62/207,357 filed on Aug. 19, 2015. The entire contents of the related application are incorporated herein by reference and made a part of this application. If any conflict arises between the disclosure of the invention in this utility application and that in the related provisional application, the disclosure in this utility application shall govern. Moreover, the inventor(s) incorporate herein by reference any and all patents, patent applications, and other documents hard copy or electronic, cited or referred to in this application.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

(1) Field of the Invention

The invention generally relates to user interfaces to manage the dispatch of commercial vehicles for livery service. More particularly, the invention relates to the use of graphical interfaces, specialized databases, geo-location services and other systems to provide real-time management, reservation and dispatch of licensed passenger transportation vehicles.

(2) Description of the Related Art

General scheduling systems are known in the related art. But, the known related art fails to provide a closed/open network system as disclosed herein.

### BRIEF SUMMARY OF THE INVENTION

The present invention overcomes shortfalls in the related art by presenting an unobvious and unique combination, configuration and use of open and closed networks, user interfaces, specialized and general computer systems to facilitate the coordinated use of a plethora of transportation entities. The disclosed transportation entities may comprise a Destination Management Company (DMC) which may comprise hotels, restaurant and other corporate users. The disclosed systems and graphical user interfaces enable a DMC to create a closed network relationship and system with a Preferred Transport Provider or PTP or TP. An employee of a DMC, such as a booking agent, concierge, executive assistant, host or doorman may generate or book a ride, on behalf of another wherein such a ride or reservation is created upon a closed network and is considered a closed network ride.

An employee, booking agent, concierge, doorman other agent of a DMC may have access to the DMC's payment methods and closed network to schedule or book rides.

A closed network provides advantages over the prior art in that a DMC may keep close control over the actions of a PTP and may negotiate rates and commissions. Thus customers of the DMC are ensured a quality of service dictated by the DMC. However, there may be instances, such when special events are scheduled, such as concerts and conventions wherein ride demand outstrips the capacity of the PTPs of the closed network. To overcome this shortfall, the disclosed embodiments seamlessly integrate the use of other transportation provides by use of an open network. In certain embodiments, the DMC's use of a PTP may be considered Farming In, while the use of an affiliate transportation provider or ATP may be considered Farming Out.

Within the disclosed embodiments, a PTP may create a Preferred Transport Provider Affiliate Network or PTPAN. Rides scheduled or executed by a PTPAN vehicle are a product of the closed network. The disclosed graphical user interfaces, databases and systems may record and/or execute commissions from a PTPAN to the PTP.

The disclosed systems and interfaces allow a PTP to build its own PTPAN, thus freeing the DMC from such responsibility and burden. A trusted PTP is motivated to carefully select members of its PTPAN in order to maintain the PTP to DMC relationship. The PTP benefits by charging commissions to rides referred to its PTPAN members.

In the event that neither a PTP nor a PTPAN can service a ride within the closed network, the ride request may enter the open network wherein the ride request is offered to Other Affiliates or OAs upon an open network. The use of OAs may be considered a Farm Out, wherein a referring PTP or PTPAN may receive a commission from the OA. Disclosed embodiments allow a DMC to schedule or book a ride within a closed network or into an open network.

### BRIEF DESCRIPTION OF THE DRAWINGS

FIG. 1 DMC Admin Panel showing connected TPs that service said DMC for Closed Network Rides

FIG. 2 DMC Admin Panel showing a first step of adding a new TP to DMC's network

FIG. 3 DMC Admin Panel showing status after sending invite to a TP

FIG. 4 TP Admin Panel showing connected DMC accounts that TP services for Closed Network Rides

FIG. 5 TP Admin Panel showing approving of pending invite for DMC

FIG. 6 TP Admin Panel showing results after setting rates for new DMC invite

FIG. 7 DMC Admin Panel showing TP has set the rates and such rates need to be reviewed by the DMC

FIG. 8 DMC Admin Panel showing the rates that the TP proposed

FIG. 9 DMC Admin Panel showing TP status to service Closed Network rides

FIG. 10 TP Admin Panel showing DMC status to service for Closed Network rides

FIG. 11 Flow Chart of DMC configuring a Closed Network

FIG. 12 Flow chart depicting steps of a new trip request

FIG. 13 TP affiliate network admin panel of a TP (a) approaching a TP (b)

FIG. 14 TP affiliate network admin panel of a TP (b)

FIG. 15 TP interface to invite affiliates

FIG. 16 TP interface to invite affiliates wherein TP (a) is approaching TP (b)

FIG. 17 TP interface in a waiting state

FIG. 18 TP interface regarding the invite of affiliates

FIG. 19 TP interface regarding the invite of affiliates

FIG. 20 TP interface regarding the invite of affiliates

FIG. 21 pseudo screen view of home page for a tap to set interface

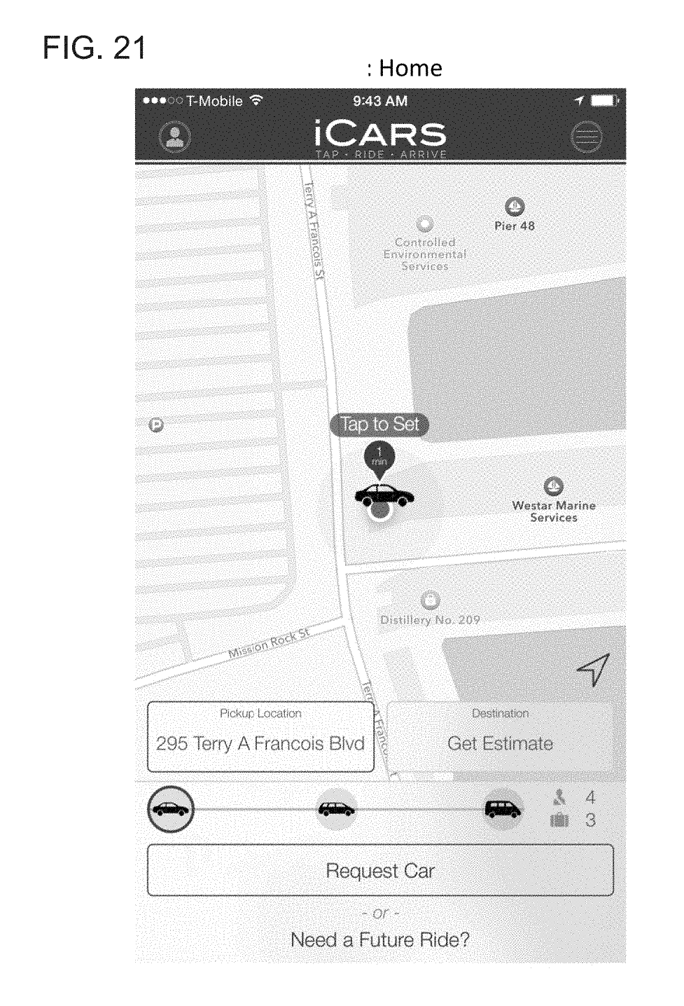

FIG. 22 pseudo screen view of a future reservation interface

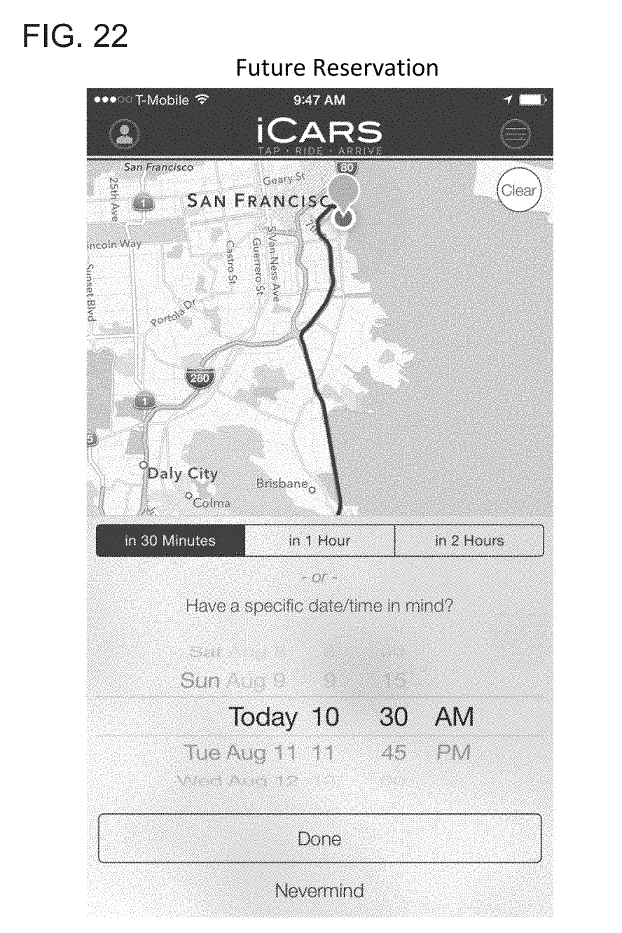

FIG. 23 pseudo screen view of a booking agent trip future reservation interface

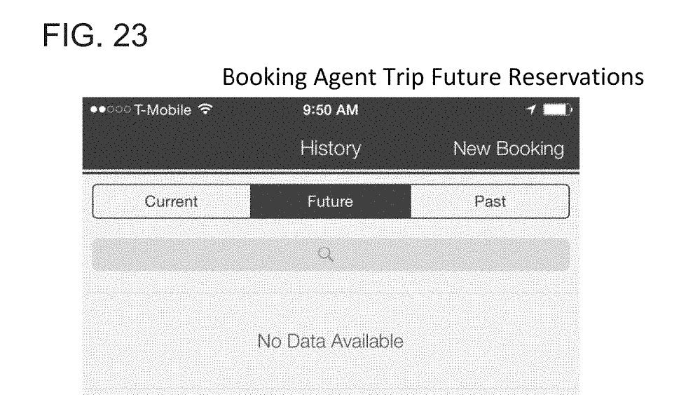

FIG. 24 pseudo screen view of a booking agent past trip interface

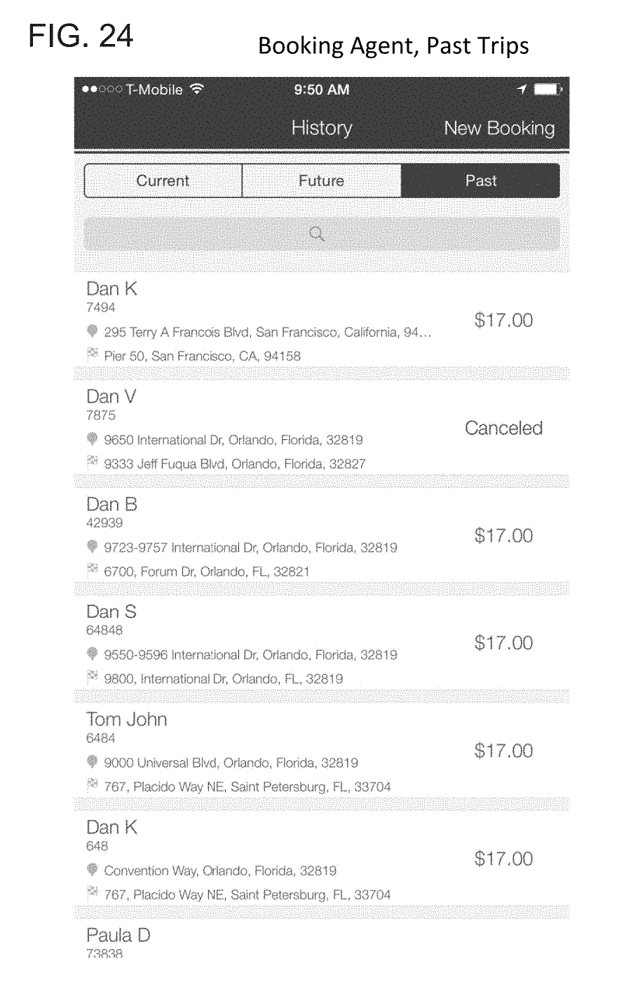

FIG. 25 pseudo screen view of a referral code and earnings interface

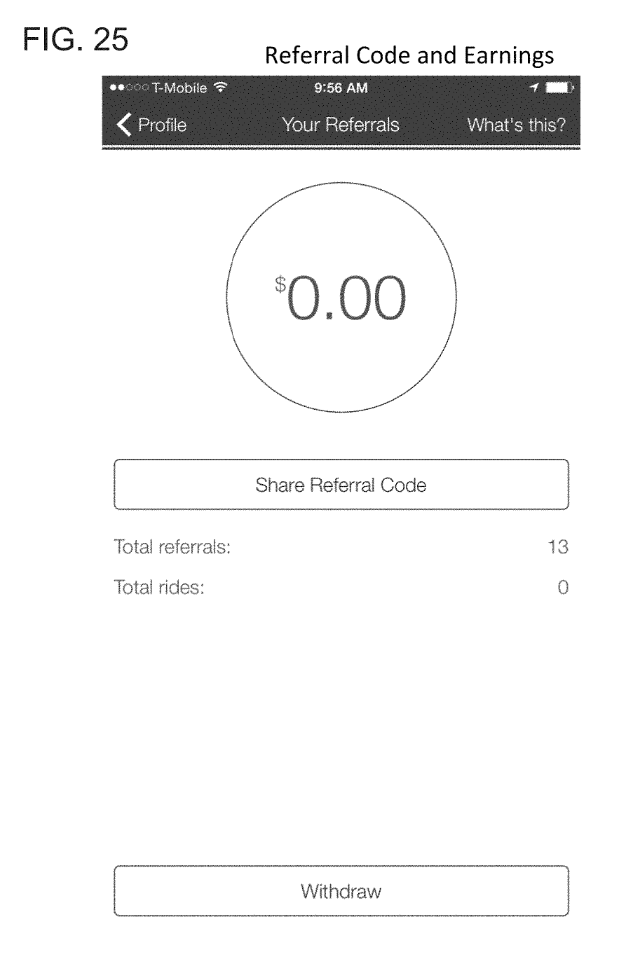

FIG. 26 pseudo screen view of a passenger future rides interface

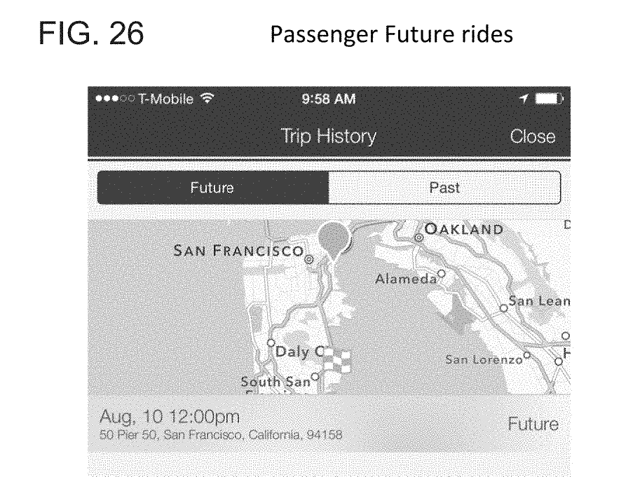

FIG. 27 pseudo screen view of a driver pre-future ride interface

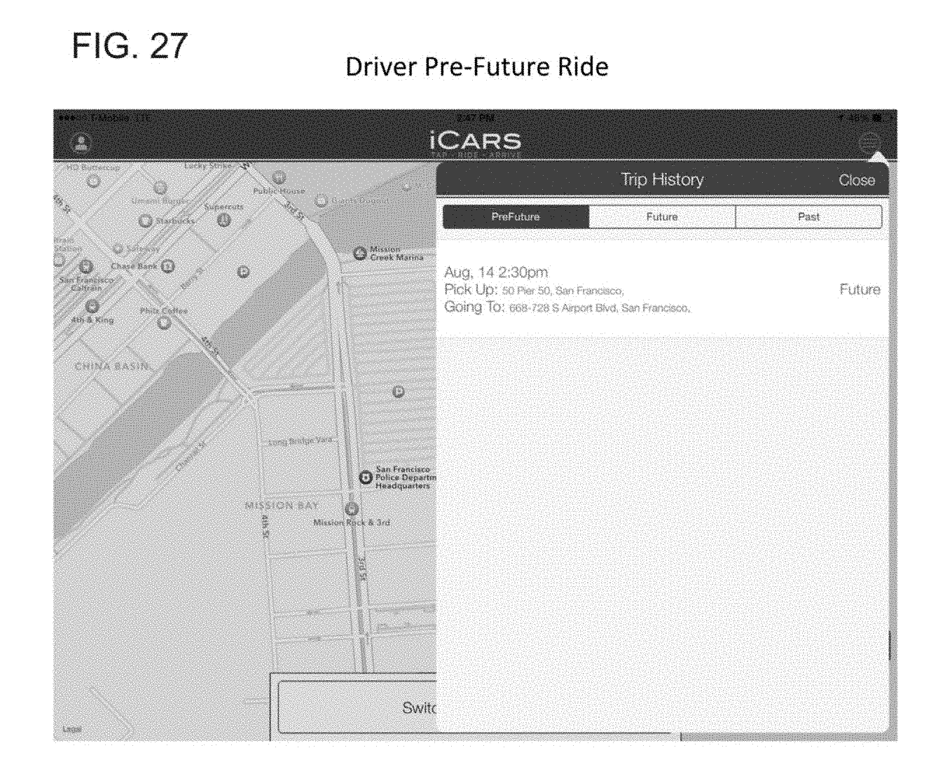

FIG. 28 pseudo screen view of a driver future ride interface

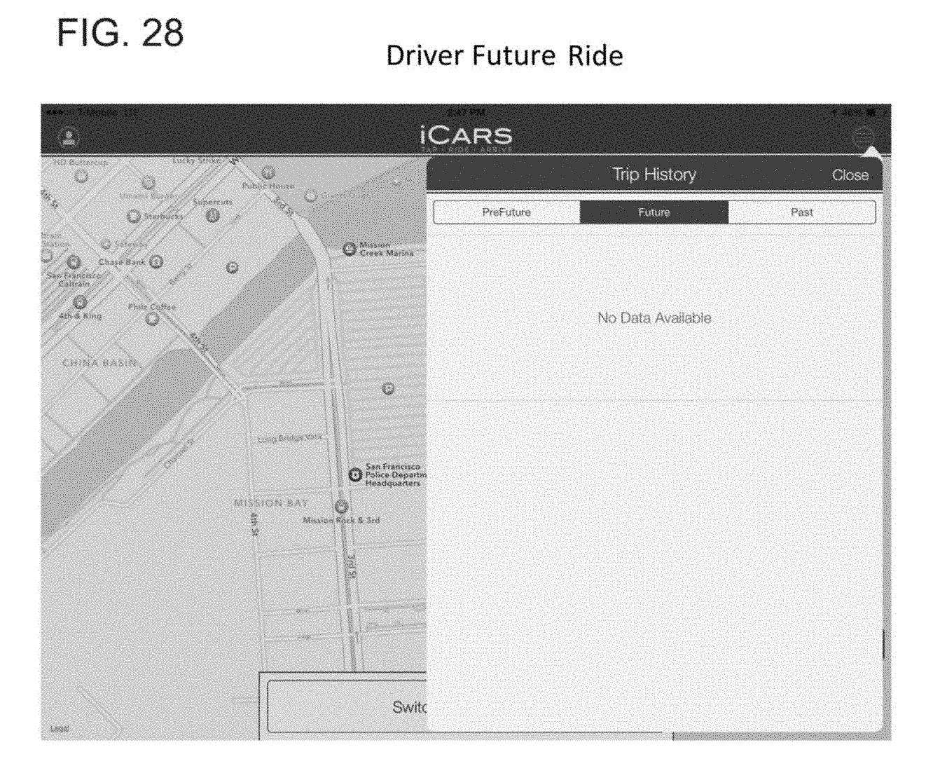

### REFERENCE NUMERALS IN THE DRAWINGS

100 interface of a DMC wherein one or more TPs may be invited or added to a closed network
120 interface for entry of TP information
130 interface for entry or selection of operating market
140 invitation information displayed upon a DMC interface 100
145 status information on a DMC invitation to a prospective TP, waiting for proposed rates from a TC
147 status information on a DMC interface, wherein TP is waiting for DMC approval
160 DMC interface showing a TP's proposed rates
165 DMC status identifier showing that a TP is available
200 a TP interface or panel
210 list of TP clients or DMCs
220 time and distance status
230 point to point status
240 rate entry interface of a TP
300 process of a DMC creating a ride within a closed network
305 actions within a DMC admin interface or panel
310 actions within a API
315 actions within a TP admin panel or interface
320 DMC sends an invite to a prospective TP
325 within an API or other platform, invite 320 is obtained
327 invite 320 is returned to the DMC admin interface as undelivered
330 message or email is sent to all prospective TPs
335 state or display wherein a DMC interface waits for a TP to propose rates
340 state or display wherein a TP transmits a proposed rate
345 email or message is sent to DMC admins
350 state or display wherein DMC reviews the proposed rates of TPs
353 some or all rates are rejected by a DMC
355 email or message sent to all TP admins
360 closed network creation has occurred
400 process of a new trip request within a disclosed embodiment
410 start state
420 new trip request
430 open or private network decision state
433 control from network decision state in the event of a negative response
435 control from network decision state in the event of a positive response
440 closed network dispatching queuing of TPs
443 control to dispatch system
445 dispatch or pining of drivers from a que
450 decision state of whether a driver is
453 a negative response in the driver decision state 450
454 overall time limit to respond to a ride request
455 cancellation of ride request and message sent to ride requestor
460 control after a driver has been dispatched
470 ride has been completed
500 interface for a TP to invite or acquire an affiliate
510 affiliate identification area
520 interface for farm out rate for affiliate
530 interface for farm in rate for affiliate
540 invite affiliate button or interface section
542 affiliate referral percentage input interface
544 an affiliate email interface
546 affiliate code entry interface
550 invite approved interface or indication

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

Disclosed embodiments move ride requests from closed to open networks when required. The disclosed embodiments set out to optimize this process by use of specialized processors and general processors, databases, and new graphical interfaces to efficiently dispatch ground transportation rides within a Closed/Open network.

Building a dispatch network on top of data entered by a DMC, the disclosed systems may create a dispatch network for Farming In/Out rides during specific events in response to capacity limits of the various ride providing entities.

By having the Destination Management Company (DMC) (Hotels, Corporations and other entities) create a closed network relation with a Preferred Transport Provider, any subsequent ride that is generated from a Passenger account associated to the DMC (employee, booking agent, concierge, doorman), may be created as a Closed Network ride.

Closed Network rides give priority to the DMC's Preferred Transport Provider first; for a given amount of response time. During the initial dispatch phase, the ride is only visible to the Preferred Transport Provider. If the Preferred Transport Provider cannot service the ride, then the system will begin creating a new Dispatch Network based on the Preferred Transport Provider Affiliate Network.

Preferred Transport Provider Affiliate Network is created by the Preferred Transport Provider. The Preferred Transport Provider may create a relation to one or many other Transport Providers within the Affiliate network. From this information, the system is able to offer the ride to only those Transport Provider(s). Again, this happens for a given amount of time. If the Preferred Transport Provider Affiliate Network does not service the ride within a prescribed time limit, the ride request may be offered to the Open Network (all other affiliates or transportation providers). The final phase (Closed to Open) can be configured by the DMC. When setting up the DMC account, the DMC can specify whether or not the system will move a ride from a Closed to Open network.

For On-Demand rides, all of the above may occur within a second. For Near Demand or Future ride requests, the time for each event may differ.

During each event, the system records at what phase the dispatcher was at to identify who serviced the ride. This is critical as each node in the network can set their own commission to earn on the ride. If the Preferred Transport Provider Affiliate was to service the ride, the system must know to pay the Preferred Transport Provider a commission as a Farm Out.

When ground transportation is requested from an established Hotel/Corporation (DMC), usually, said DMC has a Preferred TP or PTP that the DMC works with. This relationship allows the DMC to receive the expected level of service that the DMC's customers expect.

To ensure service of ride request, PTP's will have their own affiliate network. In the event that the PTP cannot service a ride, the PTP would Farm Out the ride request to an affiliate of the PTP. This allows the PTP to control the level of service and obtain commissions from affiliates. When a ride request is Farmed Out, the PTP may set a Farm Out commission.

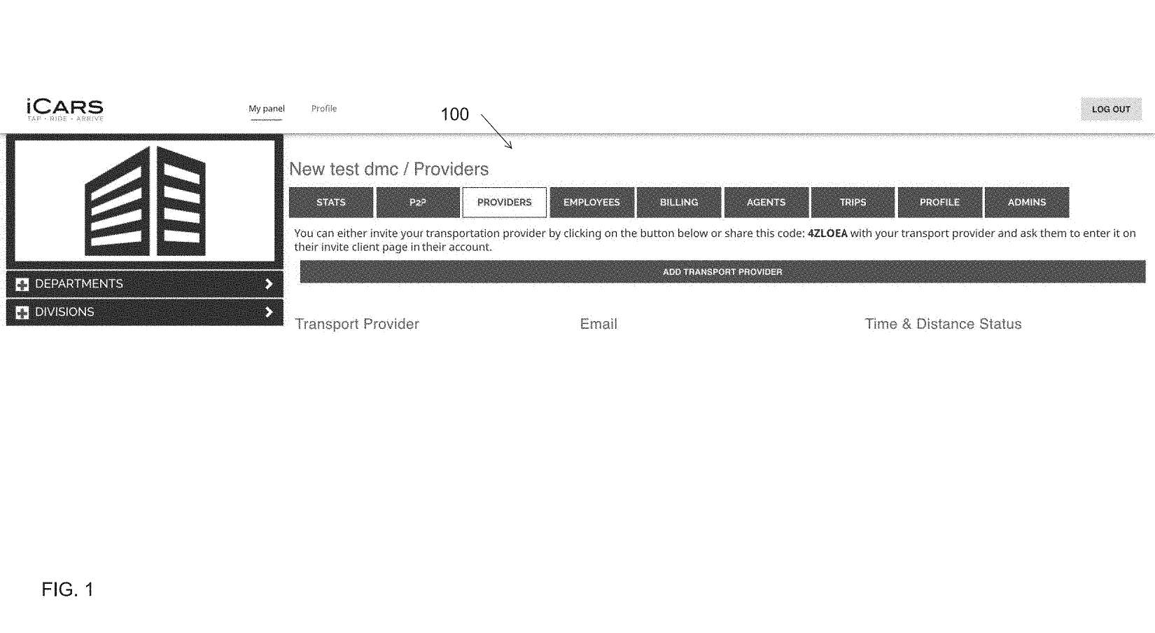

Referring to FIG. 1, an interface 100 used by a DMC to add a TP is illustrated. From the interface or admin panel, a DMC may view previously established closed networks. A DMC may view pending requests that require a TP to set rates. A DMC may view requests by TPs to set up accounts and a DMC may communicate with a TP after a TP as established an account.

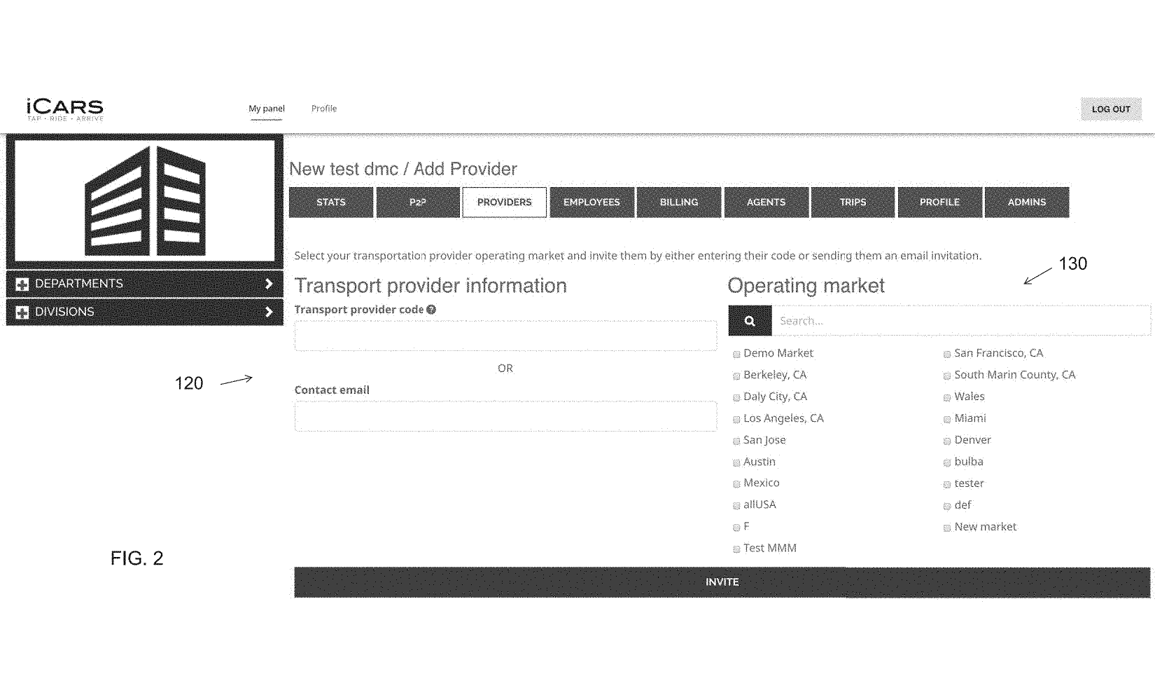

Referring to FIG. 2, an interface 120 for entry of TP information is provided and may be found near an interface 130 for the selection or entry of an operating market. FIG. 2 may depict a first step in a DMC adding a TP to the DMC's network. To that end, a DMC may send an invitation or invite code to a TP and a DMC may select a geographic market for the TP to service.

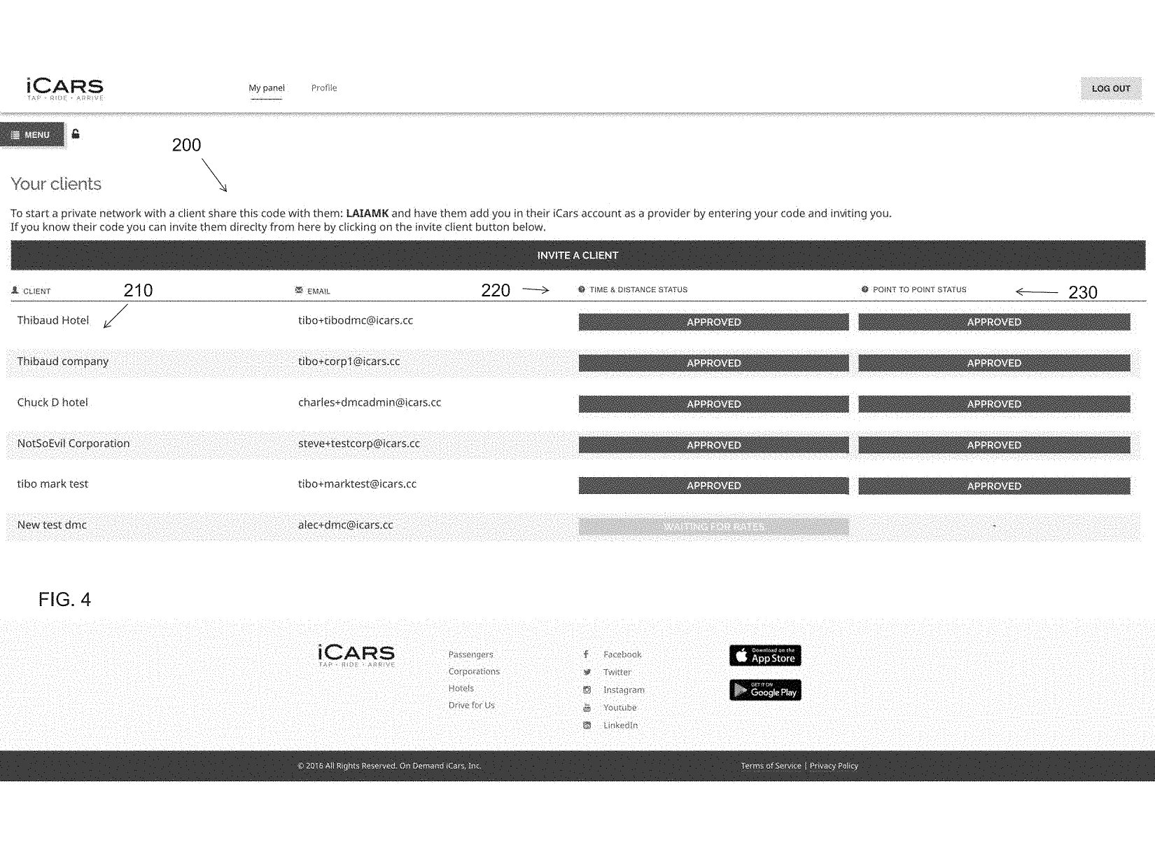

A DMC has at least two methods or options for inviting a TP to the DMC's closed network. In a first option, A TP may give the DMC the TP's invite code. In a second option, a DMC acquires email addresses or other contact information for each TP to be invited. Each invite request sent by the DMC to a prospective TP may include a market region or operating market 130. Once such invite information has been entered into a disclosed interface, the disclosed system will compare the entered information with a database of valid TP information. From the DMC request, an email to a prospective TP may be received by the prospective TP and further viewed by a TP upon a TP interface, such as the interface shown in FIG. 4 herein.

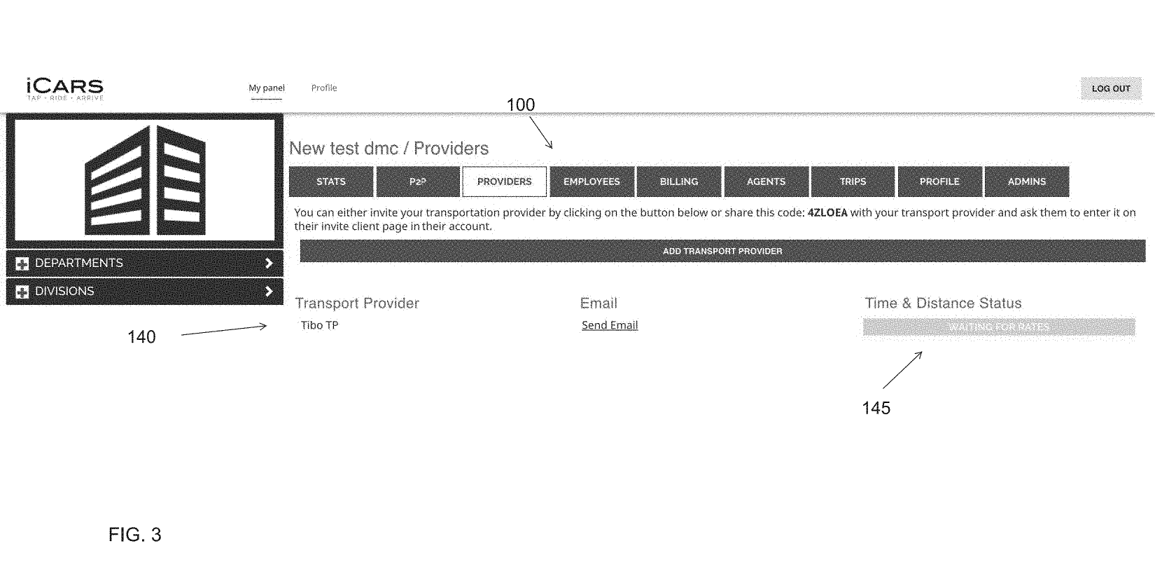

Referring to FIG. 3, an invitation has been sent to a prospective TP and invitation information 140 is shown along with status information 145, with the status information being “waiting for rates” in the given example. In the example of FIG. 3, an invitation has been sent to a potential TP or a plurality of TPs by email or other means. The DMC interface 100 shows a “Waiting for Rates” 145 status, and at this state or juncture in the process, a DMC admin or the DMC interface is enabled to send email or other communications to a prospective TP. Disclosed embodiments include the use of varying colors to denote action items and/or status identifiers.

Referring to FIG. 4, a TP admin panel 200 or TP administrative interface is illustrated and may include a listing or list of DMCs 210 serviced by the TP and may include a listing of time and distance status 220 and point to point status 230.

From the panel 200 of FIG. 4 an operator of the TP administrative interface 200 may view connected DMC accounts and each respective closed network wherein each DMC resides. An operator of the TP administrative interface 200 may view pending requests from potential DMCs and review rates to be set and may communicate electronically with a DMC.

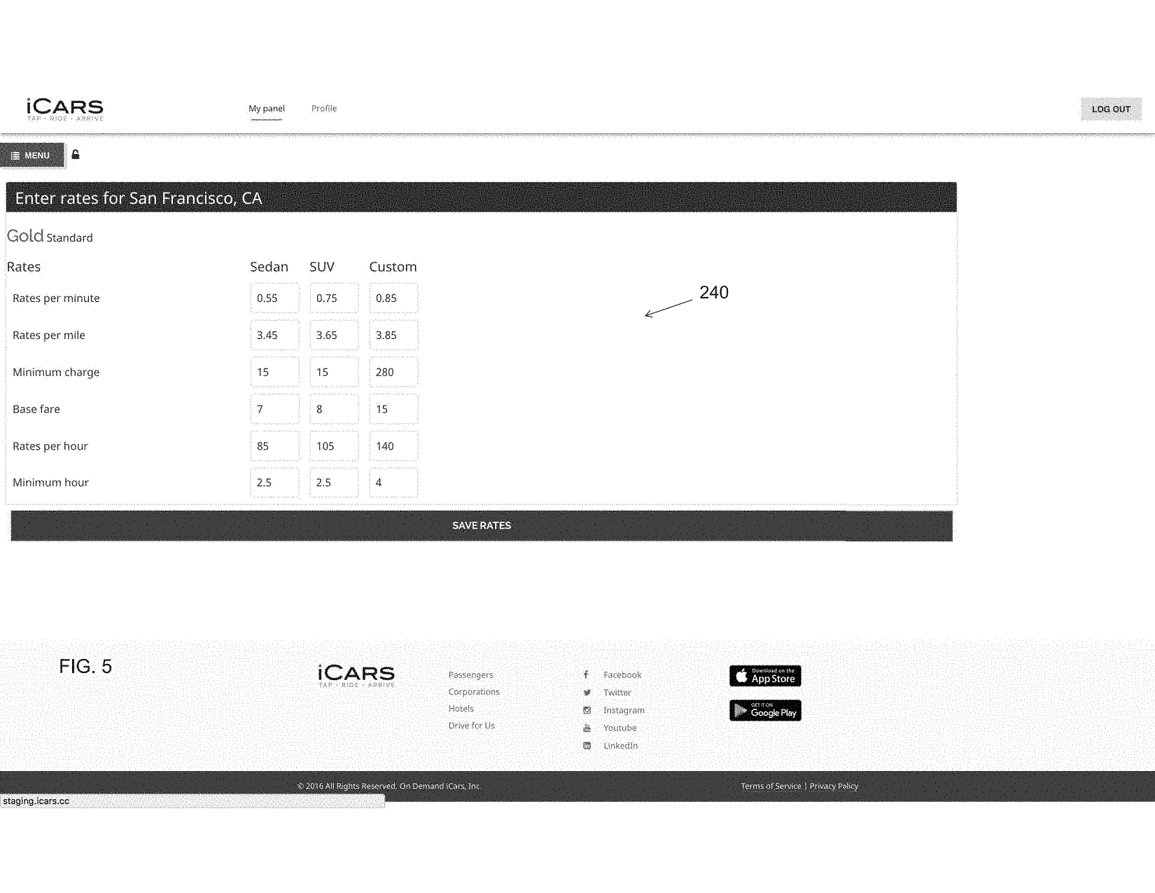

Referring to FIG. 5, a rate entry interface 240 is depicted and may be populated by the operator of the TP interface. An operator of the TP interface may set rates for each geographic market that the DMC has invited the TP to service. Disclosed embodiments may include default rates. All proposed rates may be changed by an operator of the TP interface.

A TP may be required to set rates within the TP interface for each market a DMC has requested service. Default rates may be presented within or to the TP interface and such default rates may comport with open network rates. A TP interface may not be able to continue with the acceptance of bookings until the TPs rates have been entered.

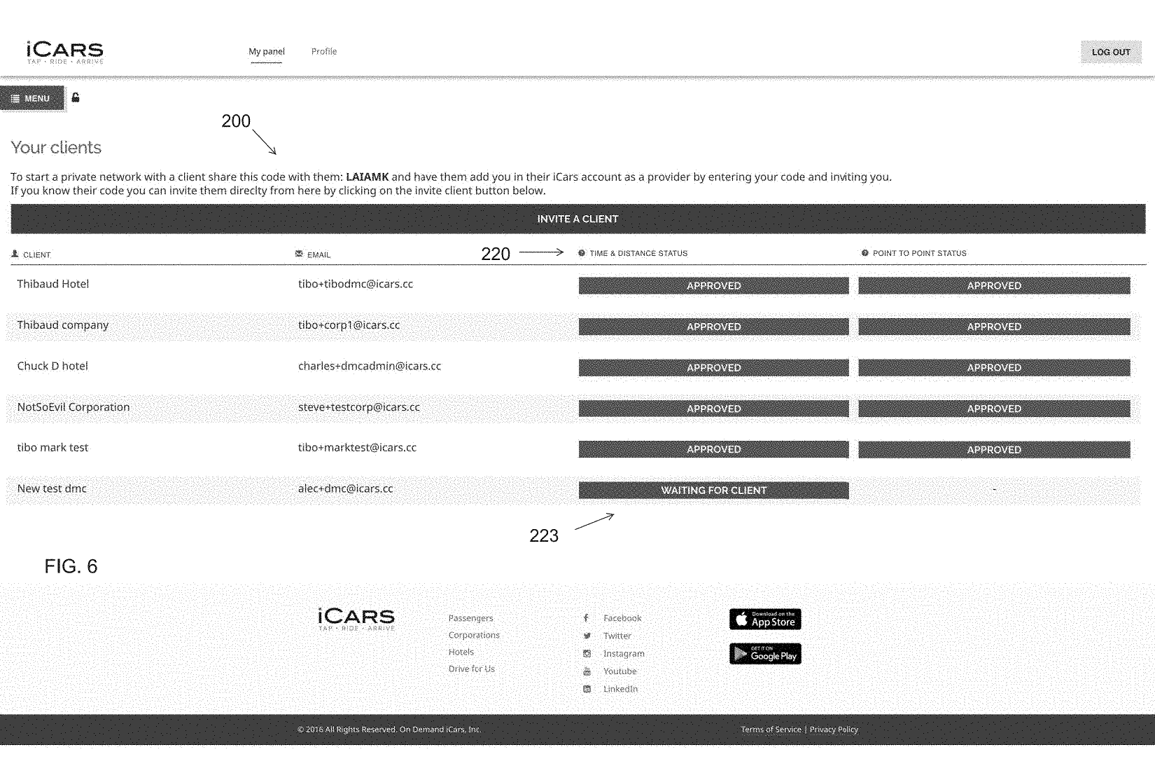

Referring to FIG. 6, a TP interface 200 is shown with a column of time and distance 220 approval status indicators. The last DMC row is shown having a “waiting for client” 223 status identifier wherein, a TP is waiting for a DMC to approve or decline the TP's proposed rate. After a TP sets a rate or a proposed rate, an invite or other communication is sent to the respective DMC such that the DMC may review the rates set or proposed by the TP.

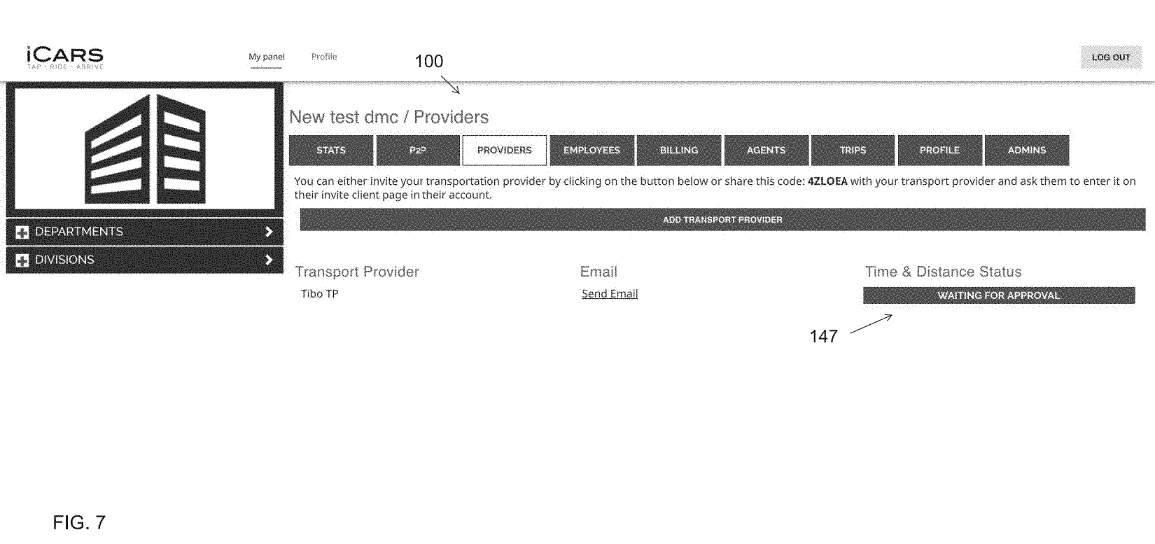

Referring to FIG. 7, a DMC interface 100 is shown with an indicator 147 showing that DMC review of a TP's proposed rates is needed. The DMC may approve or disapprove of a TS's proposed rate. The DMC interface 100 may clearly illustrate that attention is required in response to a TP's input or message.

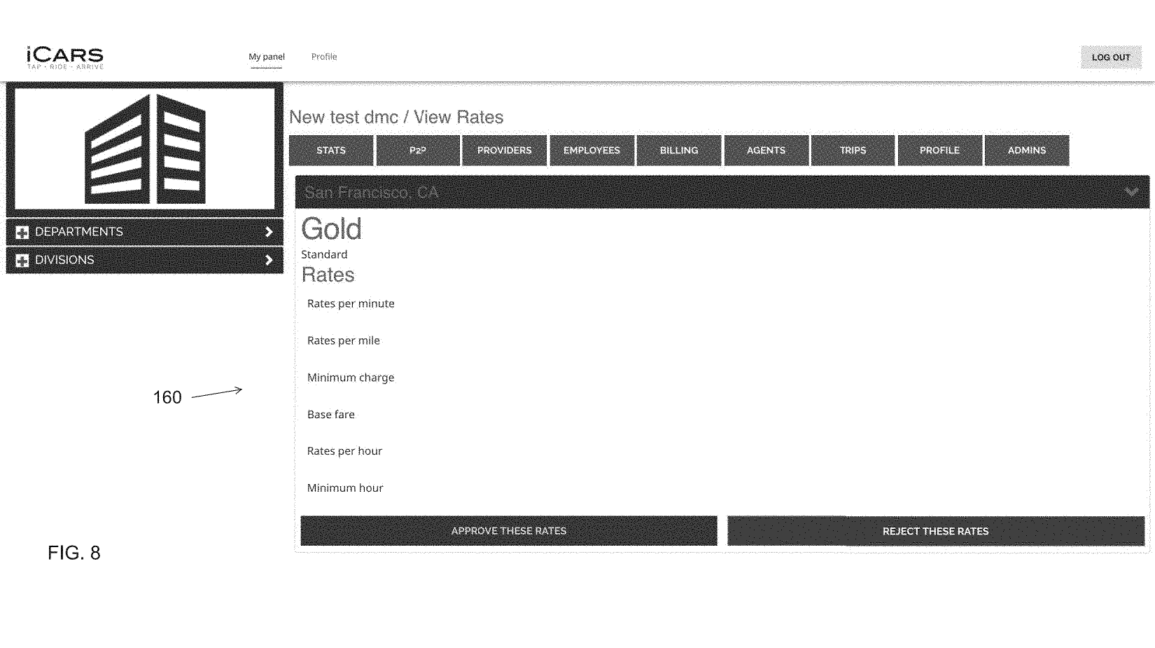

Referring to FIG. 8, a DMC interface showing a TP's proposed rates 160 is shown in a blank state. An operator of the DMC admin interface may accept or decline each rate for each established geographic market. Rates may be approved or declined on a market by market basis, thus allowing a TP to service one market, but not markets wherein proposed rates have been declined. In the event that a DMC operator rejected a proposed TP rate, the subject TP is notified and asked to provide an adjusted rate.

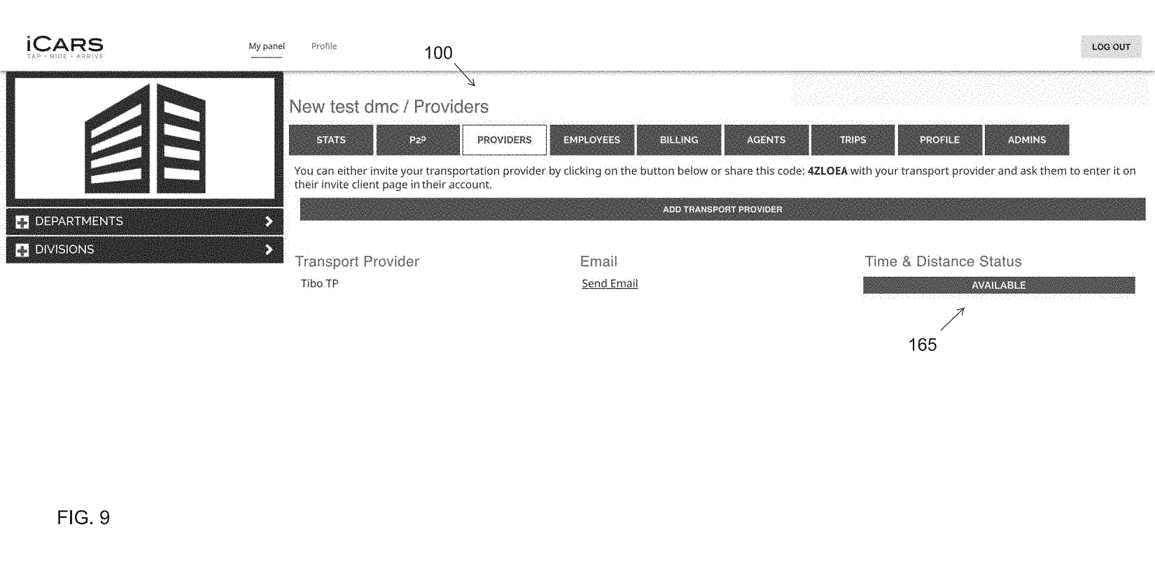

Referring to FIG. 9, a DMC interface 100 is shown wherein a TP is shown with a status of “available” 165. The interface 100 may depict a closed network of approved TPs only. The interface 100 may show a DMC the closed network is available and which TPs of the closed network are available to accept bookings of rides.

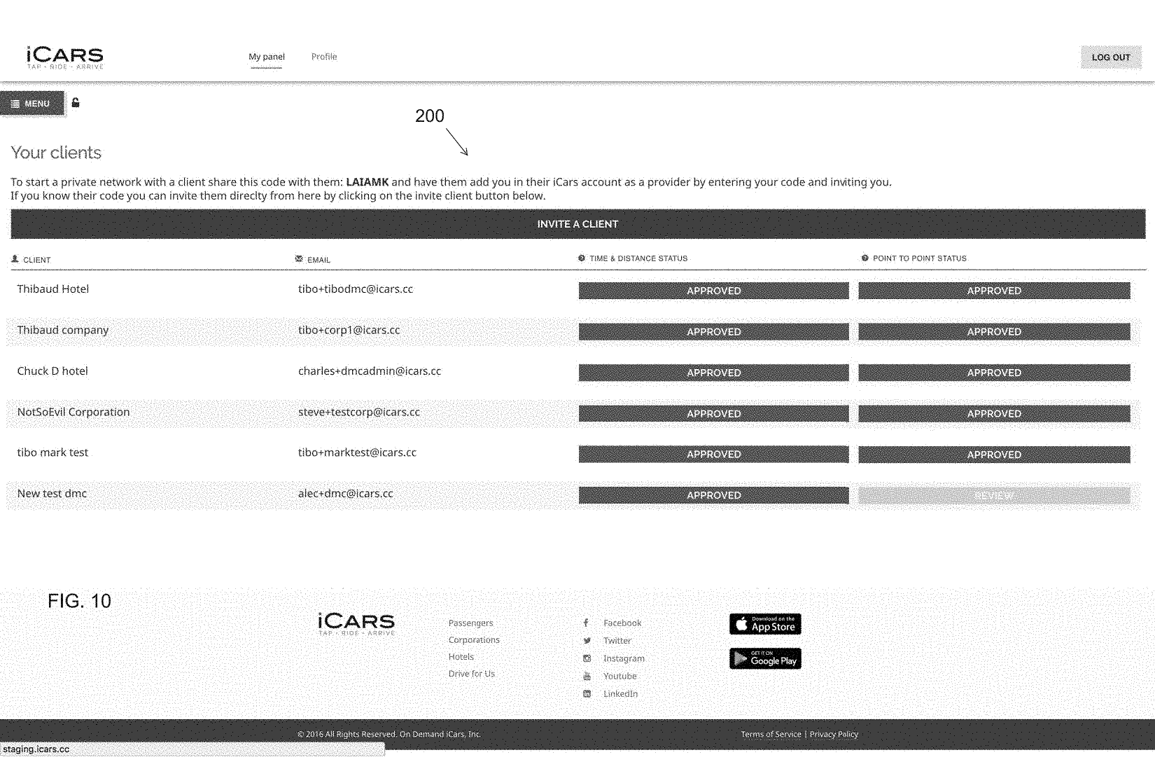

Referring to FIG. 10, a TP interface 200 depicts a plurality of closed networks, which each closed network corresponding to a client or DMC.

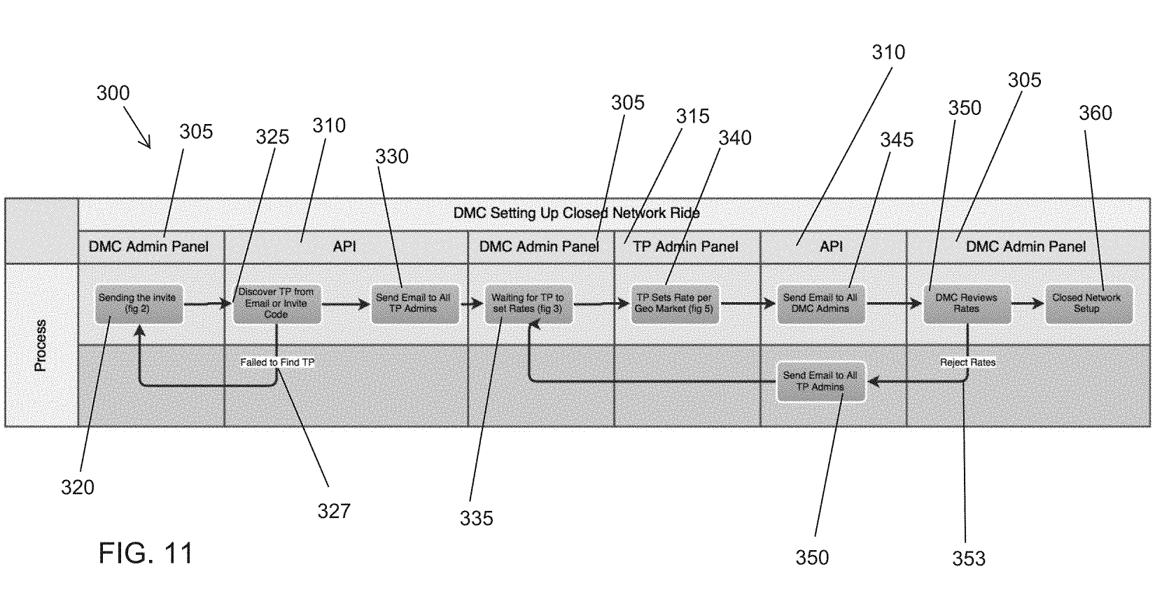

Referring to FIG. 11, a process 300 of a DMC constructing a closed network is shown. Within an admin panel 305, one or more invites may be sent 320 to one or more prospective TPs. If the invites 320 are not properly addressed, they are routed 327 back to the admin panel. Within an API or other system, discovery 325 of the invites may occur and such invites may be sent 330 by email or other means to the relevant prospective TPs. Once received by a TP, a DMC will wait 335 or display the waiting state for a TP to send proposed rates. Within a TP interface or TP system a TP may set rates 340. Within an API 310 or other system the sent rate may be emailed 345 to all relevant DMC interfaces. Upon receipt, the proposed rates may be displayed or reviewed 350 within a DMC admin panel 305. To the extent proposed rates are rejected 352, such rejections may be sent 350 to all relevant TP panels or TP interfaces back to a DMC panel waiting 335 for rates. To the extent TPs have rates accepted, a closed network 360 is created.

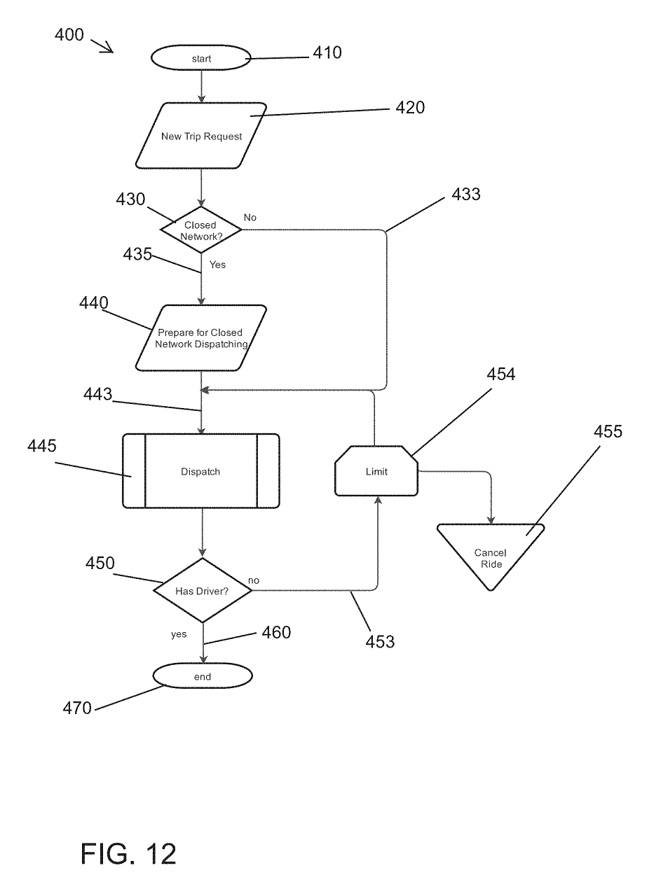

Referring to FIG. 12, a ride or trip request process 400 is shown. From a start state 410 a ride may be requested from a customer or client of a DMC. A DMC may enter a new trip request 420 and a DMC may decide if a closed or open network is used. In the event of high volume service requests, an automated subsystem may dictate a yes or no response. In the event an open network is selected, the requested is channeled 433 to dispatch for further processing. In the event a closed network system is used 435 a state of preparing for closed network dispatching is entered 440 wherein queuing occurs giving TPs of the closed network priority. TPs or associate TPs of the open network are given last priority.

In the preparation of dispatching 440, a flat fee may charged to a TP if the ride is serviced. The que of drivers are then submitted into dispatch 445 wherein organizations of TPs are selected. If a selected organization has a driver, 450 the ride is completed and the process stops 470. If no driver is available, control 453 goes back to dispatch to pull another organization. If no driver is found within a set time limit 454, the ride is cancelled 455 and a message is sent to the ride requestor.

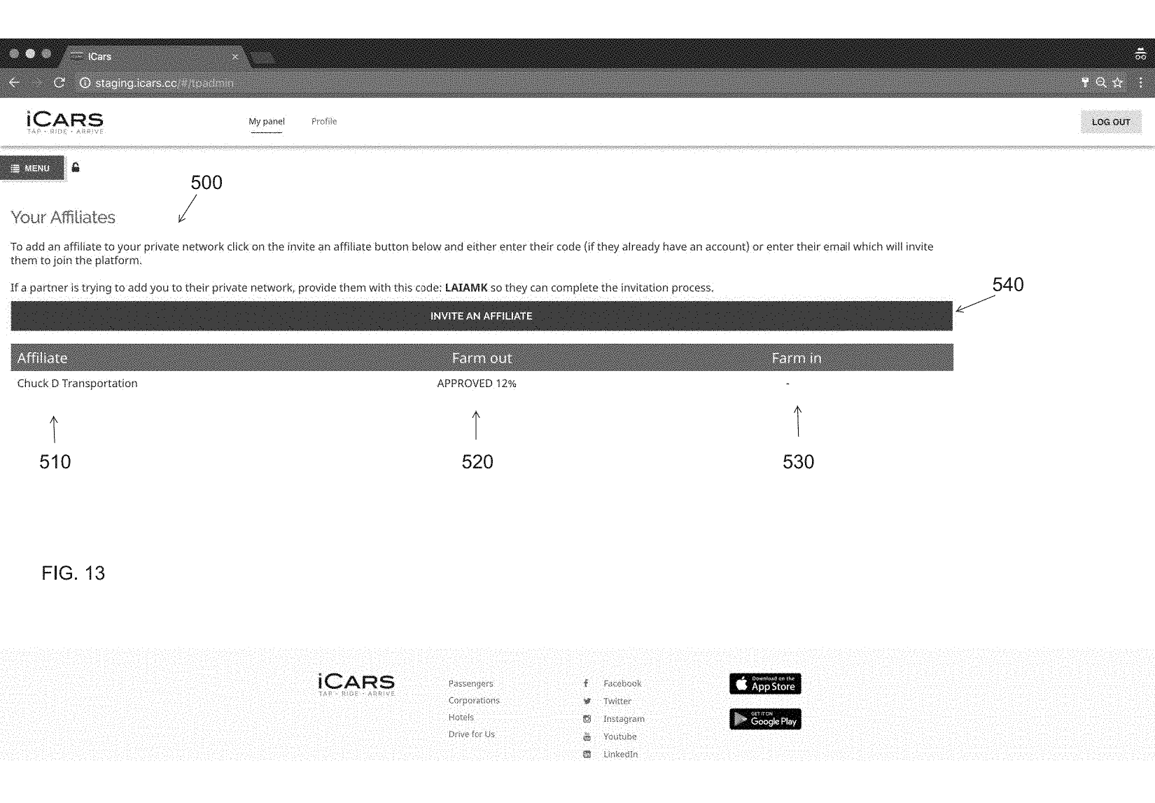

Referring to FIG. 13, a TP (a) may have an invite affiliates interface 500 which may comprise an interface area 510 to list, identify or approach affiliates, a farm out rate 520 and a farm in rate 530. A TP may view existing affiliate contacts or networks which have been established. Information as to whether an affiliate is a farm out 520 or farm in 530 entity may be reviewed and the established rates may also be viewed. In FIG. 13, a TP (a) has an established a farm out rate of 12% with a TP (d) which has been previously accepted or approved by TP (d). Thus, in the event TP (a) sends rides to TP (d), TP (d) will pay 12% commission or referral fee to TP (a).

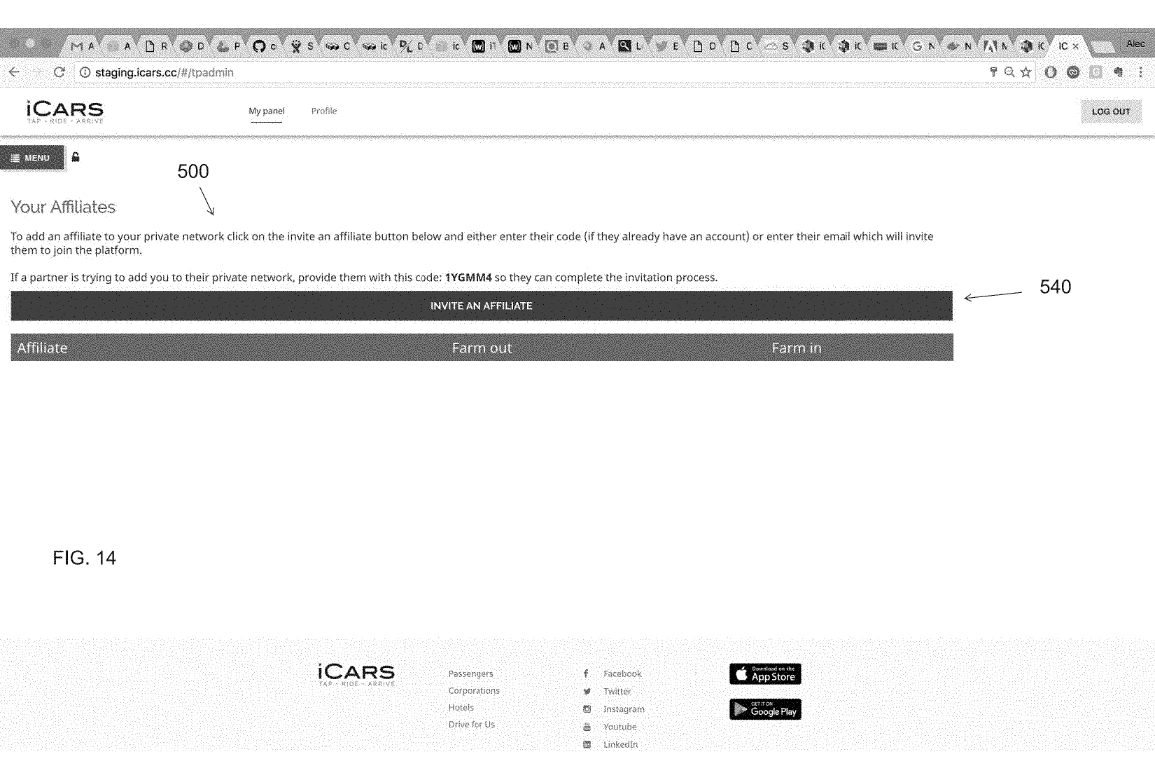

FIG. 14 depicts an invite or view affiliate interface 500 in a blank state. A TP may use the interface 500 to establish a private or closed network of affiliates. FIG. 14 depicts an affiliate interface for TP (b) wherein TP (b) has been assigned a unique code, which TP (b) may convey to other TPs of the system. FIG. 14 shows that TP (b) has yet to establish any relationships in the system.

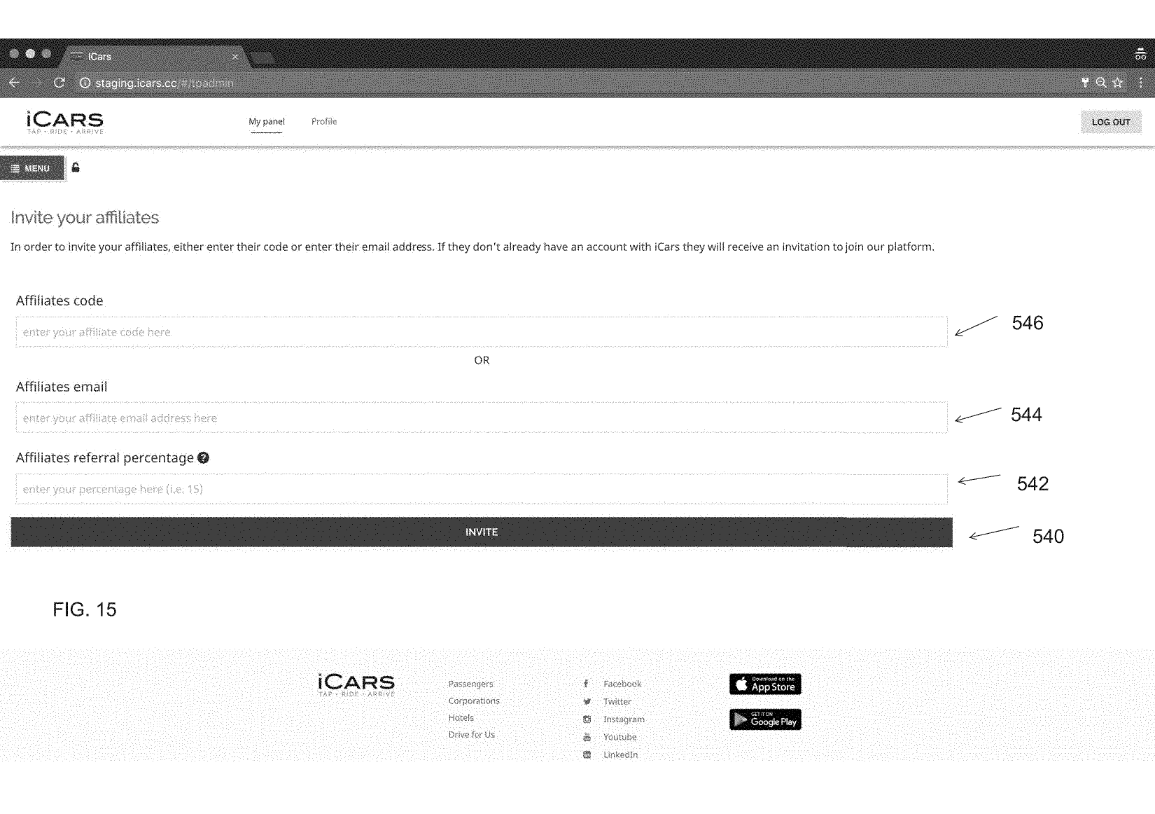

FIG. 15 depicts an interface to invite an affiliate wherein an affiliate button 540 may be activated which may trigger an affiliate referral percentage input interface 542, an affiliate email interface 544 and an affiliate code entry interface 546. The referral percentage input interface 542 may be considered a farm out fee to be paid to the referring TP. A TP approached has an affiliate my accept or decline the proposed referral fee.

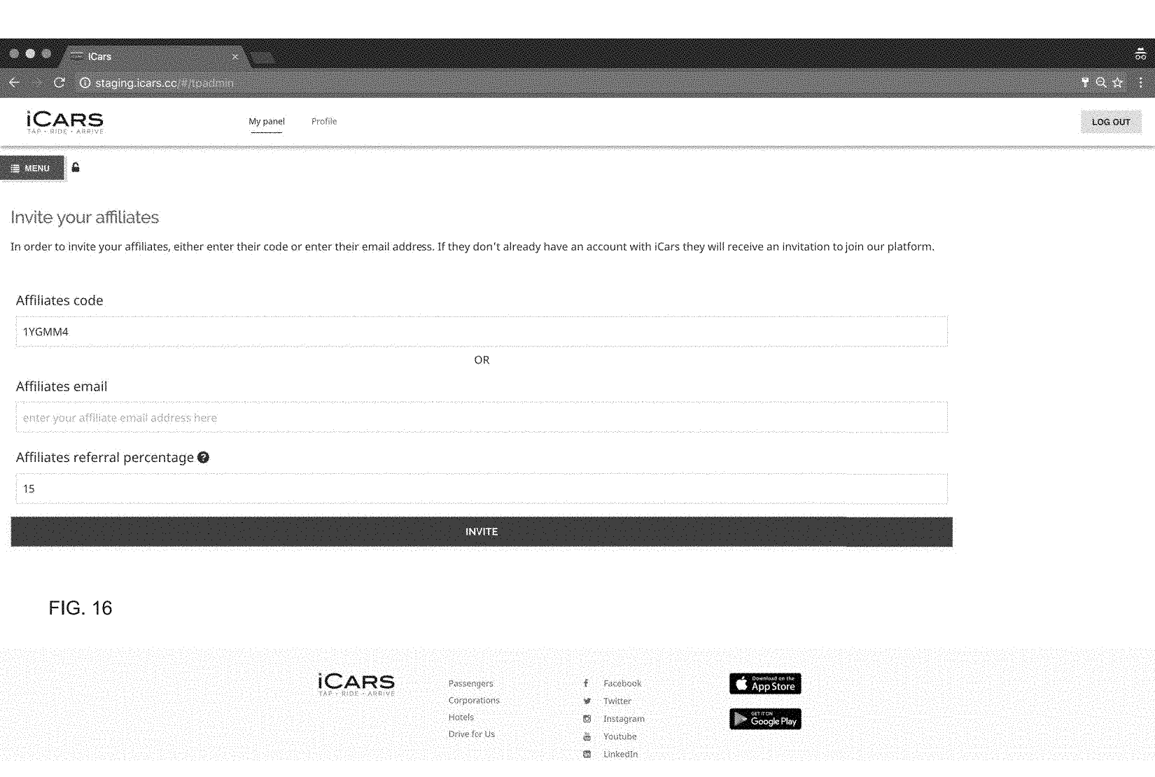

FIG. 16 depicts an interface wherein TP (a) has entered the affiliate code for TP (b) and TP (a) has requested a 15% farm out fee to be paid by TP (b). In FIG. 16 TP (a) has already discovered the affiliate code for TP (b). If TP (a) did not have the affiliate code for TP (b), TP (b) email address could have been used. This interface or invite is then transmitted within the system to TP (b) for TP (b)'s approval or decline.

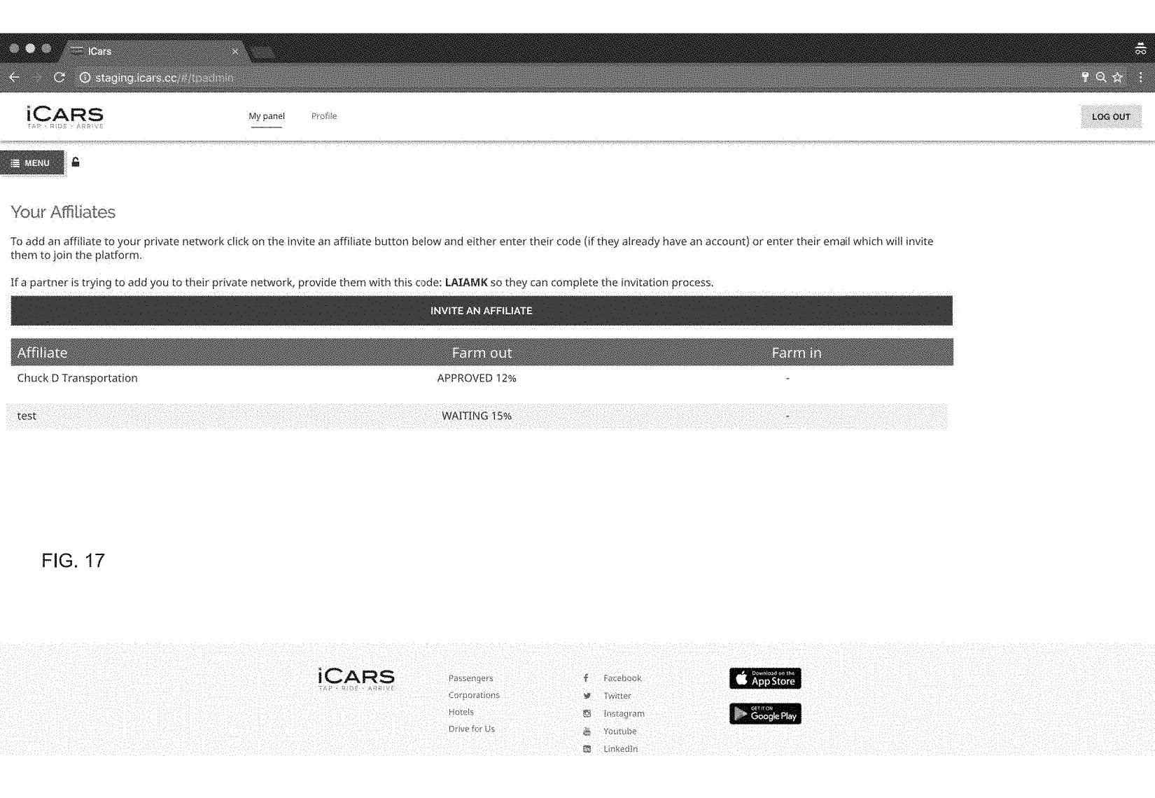

FIG. 17 depicts an affiliate interface of TP (a) wherein TP (a) is waiting for a response to the request sent to TP (b).

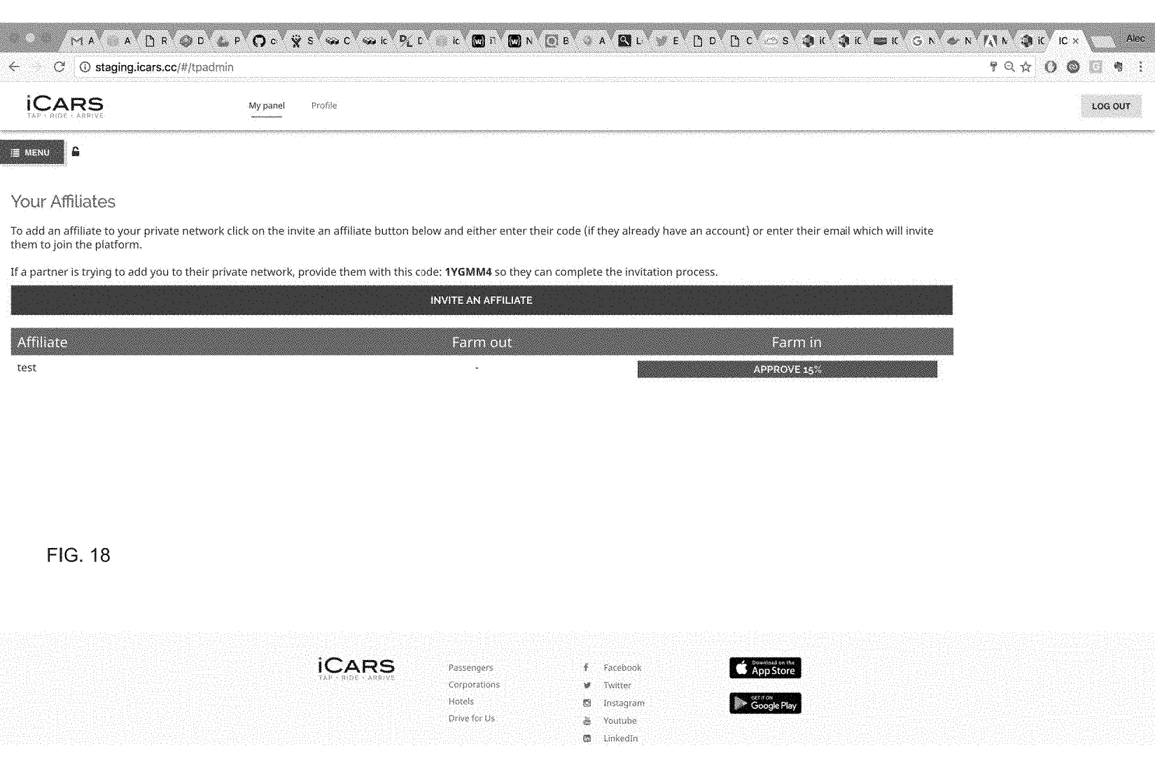

FIG. 18 depicts an interface of TP (b) wherein TP (b) has approved of the request from TP (a) and wherein TP (b) views referalls from TP (a) as the payment of a 15% farm in fee.

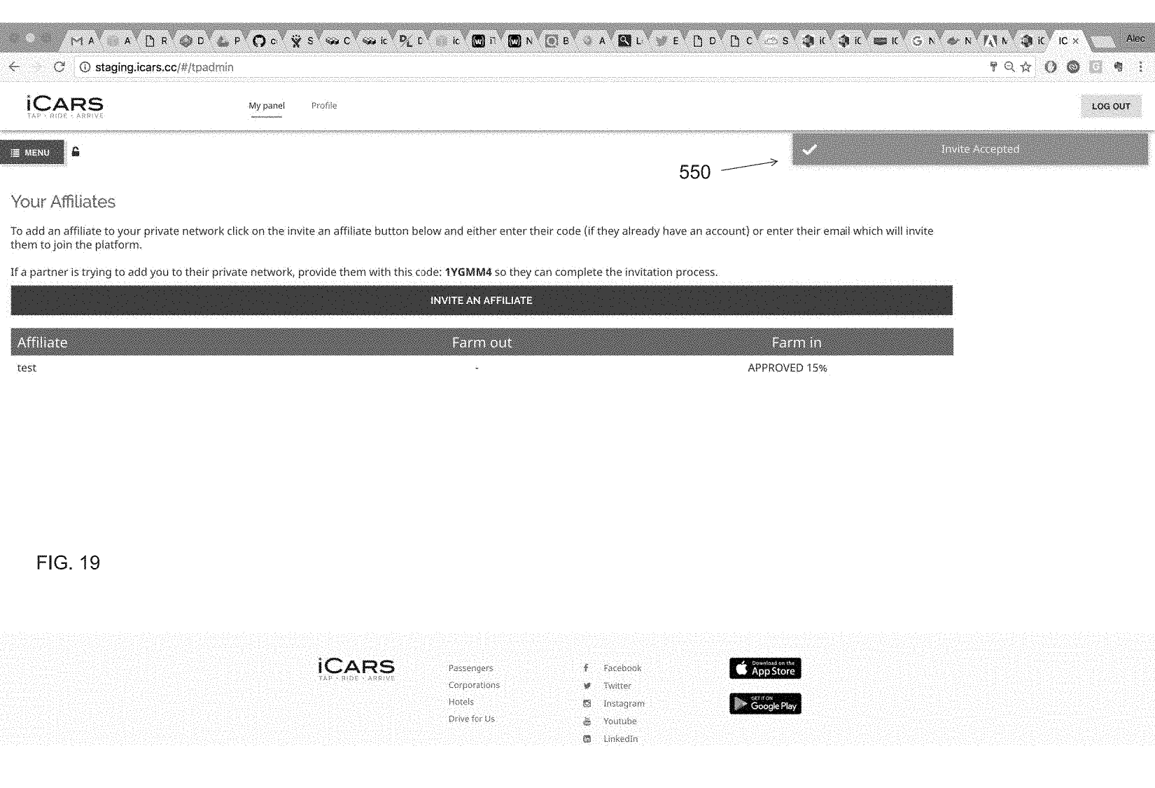

FIG. 19 depicts an interface of TP (b) wherein TP (b) has approved TP (a)'s offer as shown in a invite accepted interface 550.

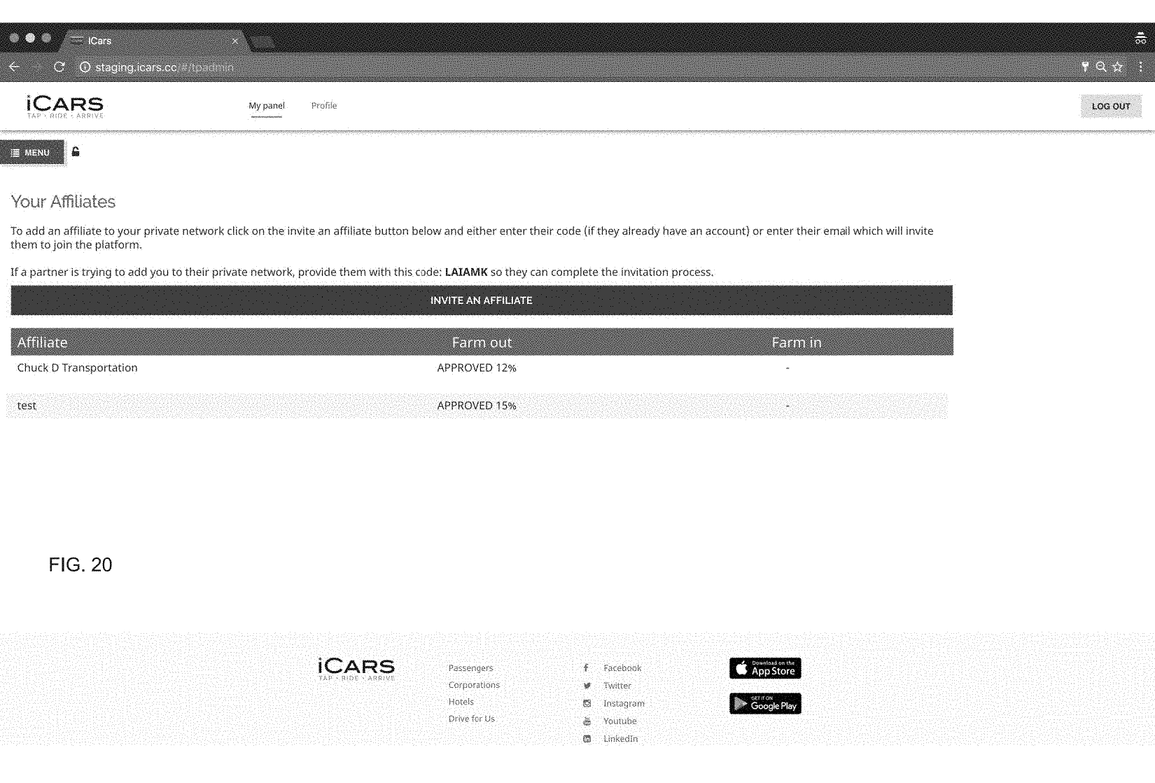

FIG. 20 depicts an interface of TP (a) showing that TP (b) has accepted the offer and is now part of TP (a)'s private network and that TP (a) will be paid 15% of the cost of rides referred to TP (b).

Duty of Care Systems

Disclosed embodiments include various duty of care interfaces and systems wherein every contact or “touch” between a carrier and a passenger is recorded and in some instances, verified in real time. For example, on the carrier side, the identity of every carrier employee, agent or associate may be verified by fingerprints, facial recognition, retinal scan and other means. Duty of care embodiments include the use of means and methods to track flights such that passengers are not stranded at airports

Other Systems, Methods and User Interfaces

Other disclosed systems, methods and user interfaces include an integration application wherein a patron may book transportation to or near an event, and then be offered tickets to the event or accommodations at or near the end point of the booked transportation. Such near end point offerings may include restaurant reservations, hotel reservations, sporting tickets, concert tickets, attractions and special events. Such offerings may be offered to clients whether or not a ride is involved and may be presented or marketed by re-marketing, re-targeting or by the use of other technologies that enable previous contact points to be interfaced. Such contact with clients may be made or influenced by the use of geolocation.

An integration platform may also include a plethora of different service levels or luxury levels such that corporate events may be serviced with appropriate price points and service levels. For example, an integration platform may include a plurality of different classes of vehicles and drivers such that executives and VIPs may receive appropriate service and lower level employees may be provide with more economical service. The prior art is replete with shortfalls in this area and thus corporations are currently forced to contact several service providers for each event.

An integration platform may also include deep links wherein a patron may be offered hyperlinks or other formats of information related to services offered or enjoyed by the patron. For example, a patron may be riding in a certain make of vehicle and then offered links to the vehicle's manufacturer.

Disclosed network closed or private network systems may include the use of flat rate fees, ongoing referrals paid for initiating a relations with the closed network. Disclosed closed or private network systems may include means and methods of allowing TPs and clients to set their own rates and for allowing TPs and DMCs to load preferred networks. Disclosed systems include means and methods of future reservations and means of accepting payment via block chain or other types of crypto currency.

A TP may include any transportation provider including a taxi, custom vehicle, black car service, sprinters, vans, shuttles, buses and limousines.

A near demand trip request may mean a request made within 30 minutes of the beginning of the ride.

The term passenger may mean an individual or a group of individuals seeking transportation. Within the disclosed embodiments, one request upon the platform may summon multiple vehicles.

Disclosed embodiments include means and methods of residual commission systems wherein a referring agent earns commissions and/or royalties for present and future rides booked again by the passenger.

Disclosed embodiments include means and methods of executing chain or split bills or payments in one single payment transaction at the conclusion of a ride.

Disclosed embodiments include means and methods of augmenting a driver's schedule based upon third party tools or third party inputs, such as flight tracking applications.

Disclosed embodiments include means and methods of enabling a DMC to create employee subaccounts wherein one system instance or application may be used by many users.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

What is claimed is:

1. A system comprising a series of graphical user interfaces used to establish the creation of a private network of transportation providers wherein a destination management company (DMC) selects and is networked with a plurality of transportation providers (TPs) and wherein each TP may select and establish a private affiliate network with affiliate transportation providers (TPS), the system comprising:
a) a DMC interface (100) comprising an entry of TP information interface (120) and an operating market entry interface (130), the DMC interface further comprising an invitation information display (140) listing the names of invited TPs;
b) a TP interface (200) comprising an interface of networked DMCs (210), an interface of time and distance status approvals (220) and an interface of point to point status approvals (230), a rate entry interface (240);
c) an affiliate interface (500) for a TP to establish the TPs private affiliate network, the affiliate interface comprising an affiliate identification area (510), an interface for the display of farm out rates (520), an interface for the display of farm in rates (530) and an invite affiliate interface (540) with the invite affiliate interface comprising an affiliate referral percentage input interface (542).

2. The system claim 1 further including a trip fulfillment system (400) using the private network of claim 1, the trip fulfillment system comprising a trip request interface (420) connected to a an open or private network decision state (430) connected to a closed network dispatching subsystem (440) connected to a dispatch system (445) giving priority to TPs of the closed network first, and secondary priority to TPs of an open network.

3. The system of claim 2 wherein the trip fulfillment system is populated with on-demand trip and or/near demand requests.

4. The system of claim 2 wherein the trip fulfillment system is populated with future demand trip requests.

5. The system of claim 1 further including an tap to set interface used to set the location of a passenger to receive service from a TP.

6. The system of claim 5 further including a looking for estimate interface used by a passenger to receive an estimate of trip cost.

7. The system of claim 5 further including a future reservation interface used by a passenger to reserve service from a TP at a future time.

8. The system of claim 5 further including a history interface depicting past trips of a booking agent.

9. The system of claim 5 further including a rebook for passenger interface.

10. The system of claim 5 further including a duty of care interface wherein every contact with a passenger is recorded and available via multiple communication methods.
